(19) United States
(12) Patent Application Publication
(10) Pub. No.: US 2007/0095234 A1
(43) Pub. Date: May 3, 2007

(54) Fabric printing having three-dimensional illusion

(76) Inventor: Arius Hopman, Hanapepe, HI (US)

Correspondence Address: HOFFMAN, WASSON & GITLER, P.C.;CRYSTAL CENTER 2, SUITE 522, 2461 SOUTH CLARK STREET, ARLINGTON, VA, 22202, US

(21) Appl. No.: 11/259,254

(22) Filed: Oct. 27, 2005

(51) Int. Cl. B41F 17/00

(52) U.S. Cl. 101/483; 101/35

(57) ABSTRACT

Advances in digital imaging, half-tone printing and printing of the entire garment combine to provide realistic optical illusions of three dimension on garments or fabric. Throughout this application, “fabric” means cloth, film, or any pliable and wearable, utilitarian or aesthetic material. Crude air brush simulations or hand illustrations have herein been replaced with digitally or physically “flattening” an image of a three-dimensional object which is printed on flat cloth and reassembled to provide an illusion of three dimensionality when worn as a garment. The flattening process renders the image of a three-dimensional object as a two-dimensional image that is minimally stretched, shrunk or distorted compared to the original three-dimensional objects, unlike rectangular world maps, for instance, which are distorted to represent a spherical globe on a flat surface. The flattened images of three-dimensional objects when printed and worn can simulate a knight's armor, flowers or jewelry, ethnic costumes or nightgowns including intricate folds and details. Such image preparation and printing on a garmnet results in a printed optical illusion of three-dimensionality that relates to the wearer's body in a visually meaningful way.

### BACKGROUND OF THE INVENTION

Since the first cave paintings tens of thousands of years ago to the present, there has been a progressive attempt to represent the three dimensional world in two dimensional art and graphics. Flat art slowly evolved to include shading, foreshortening, and realistic looking relief. This trend culminated first with film photography and now with digital photography and photo realism in the art world. We are on the frontier of holographic media.

The present invention takes advantage of and builds on the recent surge of advances in digital photography and computer programs that create and manipulate digital images. Digital imaging and digital printing have opened up new frontiers of possibilities for the development of three dimensional optical illusions printed on fabric.

The retail garment market encounters billions of dollars worth of sales each year. T-shirts having slogans, logos or sayings are meant to capture the imagination and, through popularity, generates sales for hundreds of thousands of units. T-shirts designs, such as t-shirts simulating a tuxedo have proven popular but the illusion is not realistic. The casual observer quickly realizes that the printed lapels, collar, carnation, or accessories normally associated with a tuxedo are flat, unrealistic illustrations.

U.S. Pat. No. 4,656,065 (Yacovella) discloses a camouflage cloth having a pattern simulating the bark of a tree. Shading is used to simulate three dimensions, including the roundness of a tree trunk. U.S. Pat. No. 5,009,626 (Katz) discloses a method of taking a picture of a three dimensional object and flattening the image onto two dimensional paper for the purpose of making doll heads.

### SUMMARY OF THE INVENTION

Advances in digital imaging, half-tone printing and printing of the entire garment combine to provide realistic optical illusions of three dimension on garments or fabric. Throughout this application, “fabric” means cloth, film, or any pliable and wearable, utilitarian or aesthetic material. Crude air brush simulations or hand illustrations have herein been replaced with digitally or physically “flattening” an image of a three-dimensional object which is printed on flat cloth and reassembled to provide an illusion of three dimensionality when worn as a garment. The flattening process renders the image of a three-dimensional object as a two-dimensional image that is minimally stretched, shrunk or distorted compared to the original three-dimensional objects, unlike rectangular world maps, for instance, which are distorted to represent a spherical globe on a flat surface. The flattened images of three-dimensional objects when printed and worn can simulate a knight's armor, flowers or jewelry, ethnic costumes or nightgowns including intricate folds and details.

It is an object of the invention to preserve the illusion of a true three dimensional object in a two dimensional print, such as on a garment, in particular when being worn so that the underlying relief of the wearer's body fits the printed illusion of relief on the fabric. It is a further object of the invention to print any photographically precise three dimensional illusion on fabric, even if the illusion does not refer to the underlying body.

It is another object of the invention to provide processes for converting a three-dimensional object or objects to a two-dimensional print on fabric or a garment providing an illusion of realism when worn or used in any utilitarian or aesthetic manner.

These and other objects of the invention will become apparent to one of ordinary skill after reading the disclosure of the invention.

### BRIEF DESCRIPTION OF THE DRAWINGS

FIG. 1 is an illustration of how photographs are taken in the first step of flattening photographically;

FIG. 2 represents the photos being assembled once taken by the method shown in FIG. 1;

FIG. 3 are the photos of FIG. 2, applied to a flat piece of cloth;

FIG. 4 is the first step in flattening physically;

FIG. 5 is the second step in flattening physically;

FIG. 6 is the third step in flattening physically; and

FIG. 7 depicts using the physically flattened cast to create a photograph retaining the three dimensional illusion.

### DETAILED DESCRIPTION OF THE INVENTION

A first method for creating a body specific garment having a 3D illusion is by photographic flattening. In this method, a series of photographs are taken of the appropriately decorated, adorned or clothed subject from various angles. For instance, as seen in FIG. 1, to create the front panel of a t-shirt, a first photograph is taken by a camera 12 directly in front of a person wearing the item to be simulated. The second and third photographs are taken from cameras 14,16 at positions rotated 45 degrees in a horizontal plane from the first photograph. Fourth and fifth cameras 18,20 take photographs rotated 45-degrees in the vertical plane from each of the second and third cameras. In this example, five photographs are created, but more cameras may be used.

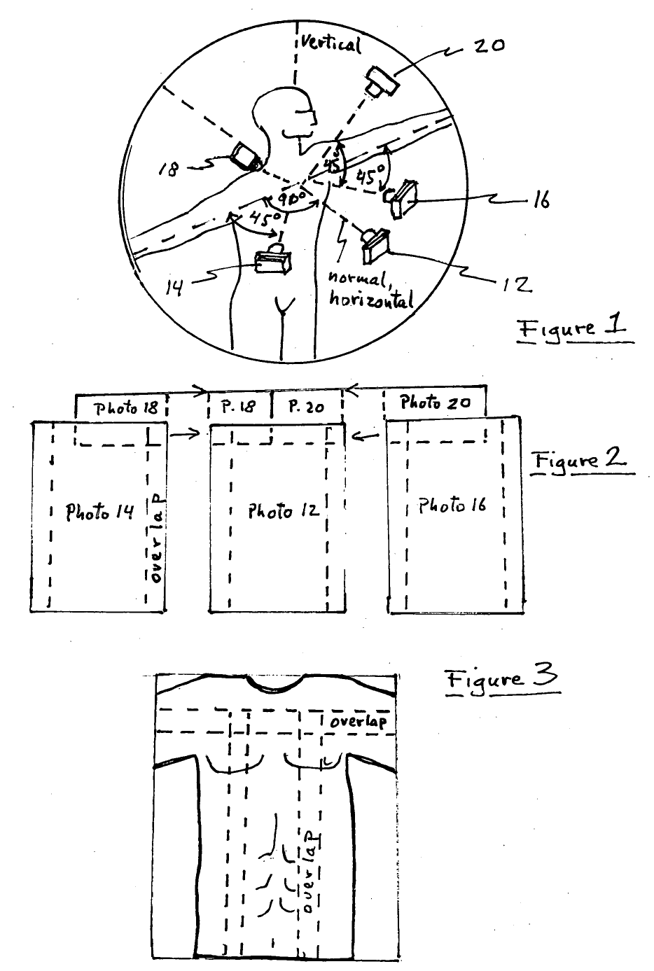

The photographs are then digitally or manually overlapped to create a seamless picture of the front, top and sides of the person wearing the item to be simulated, as seen in FIG. 2. This is like “peeling” or “flattening” the surface of a three dimensional object. The photographs are seamlessly merged, digitally or manually, to form one panel creating a flattened image of the three dimensional front of the person. As can be seen in FIG. 3, the resultant merged panel, created from the five photographs, is then printed onto a piece of cloth or film, which is formed into the front panel of the garment. The sleeves are printed separately or simultaneously with the front panel. The same procedure is repeated for the back panel of the garment, if the image is to extend around the entire circumference of the torso. Legs and arms can also be included in the printed illusion.

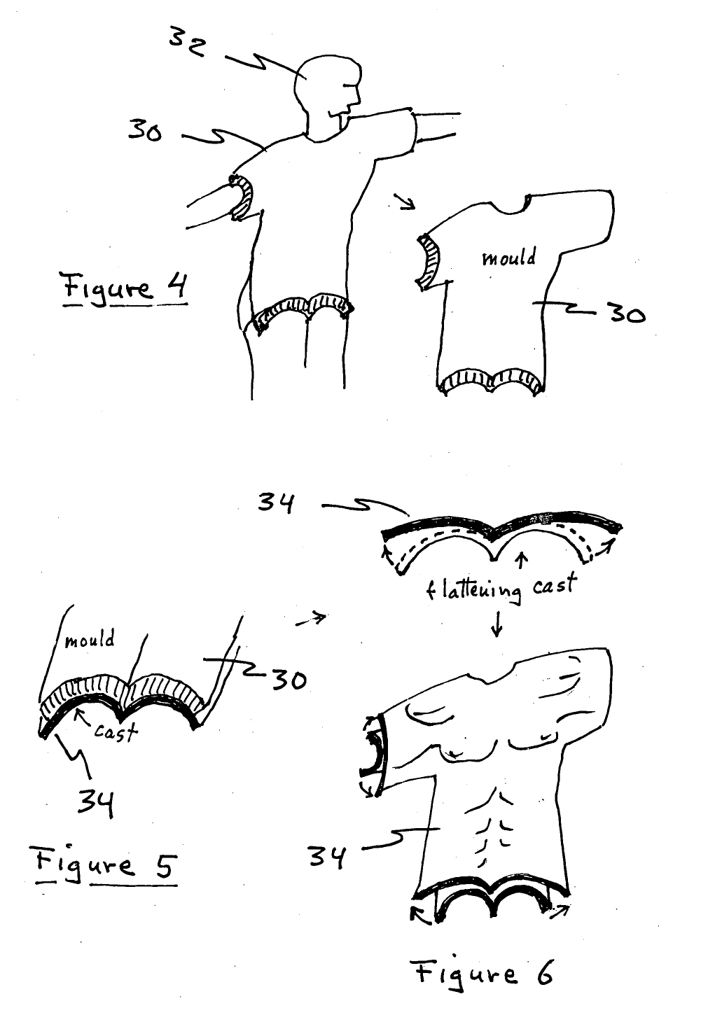

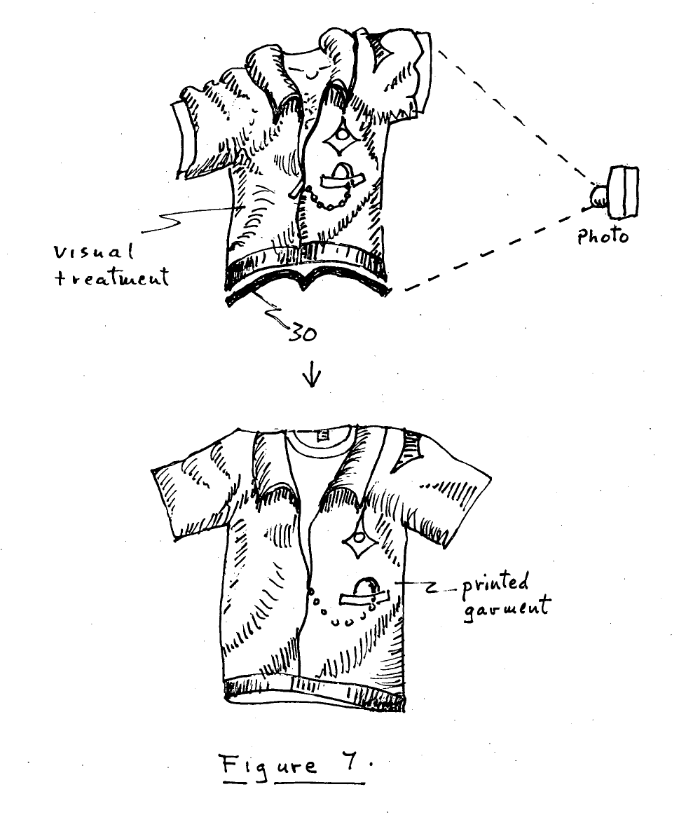

A second method for “flattening” a three-dimensional object or objects to be printed on clothing is to create a set of precisely and partially flattened body casts. A male and female torso body cast would be needed as re-usable templates to create male and female printed garments. The casts can be formed in the traditional sculpture manner by creating a negative mold of a person, as seen in FIG. 4. The mold 30 is formed on a model 32 and removed when hard. The negative mold 30 is then used to make a positive relief replica: the cast, 34 of the torso in a pliable material maintaining all three-dimensional detail of the model from which the cast was made. Examples of suitable pliable materials include rubber, latex and clay.

The positive relief replica (cast) of the front 34 covers at least 180 degrees of the 360 degree horizontal circumference of the torso. The same procedure of making a mold and cast is repeated for the back of the model. This second cast of the back also covers at least 180 degrees of the 360 degree circumference of the torso. By extending over 180 degrees, overlap at the side edges of the garment is created for the seams of the garment.

Once the cast 34 is formed, it is partially flattened as seen in FIG. 6. Once the cast comes out of the mold, the edges are initially curved because the body is curved, as seen in the dashed lines, but the edges are flattened to approach by about 45 degrees the front center plane of the cast. Although the cast is flattened by bringing the edges toward the same plane as the center section, the three dimensional relief of the models anatomical detail are preserved. As seen in FIG. 6, where a front and back panel of a t-shirt would be joined, the edges of the pliable cast are manually flattened out to approximately 45 degrees from the frontal plane and extended out approximately an inch, creating an overlap of images to accommodate stitching and seaming between the front and back panel. Similarly, the arms are opened up and the cast is hardened. The cast is then painted, gilded adorned, draped, clothed or decorated with the three dimensional objects to be photographically simulated, as depicted in FIG. 7. Then only one photograph is needed to capture the correct illusion to print. This single photograph can be used to form the print on the front of a garment. The process is repeated with the cast of the model's back to obtain a single photograph forming the back of the garment. The closer the garment wearer's physique matches that of the model and the cast made from the model, the greater the three dimensional illusion will be maintained once the garment is printed and worn.

Once the photographs are taken, by either the photographic flattening or physical flattening as previously described, there are two ways to print the entire garment to retain the optical illusion. The first method is to pre-cut fabric patterns, print them with the optical illusion, and sew the patterns back together. The second way is to pre-sew the garment and then apply the printing to the garment itself. In order to effectively print both sides of a piece of clothing, it is necessary to stretch the garment onto a rigid flat board armature having minimum thickness. When printing is done, the front and back of the sleeves are done at the same time as the front and back of the rest of the garment. The minimum thickness minimizes edge phenomena from occurring when the front and back of the garment are printed separately.

Fine modern knits and weaves enhance the optical illusion as it is possible to print extremely fine and precise images on the cloth. Other materials, such as wearable film, make even more precise prints possible. Direct to garment inkjet printing results in images on fabric that can be seen but not felt, referred to in the printing trade as “soft hand”.

There are two categories of printed 3D illusions covered in this application. The first, as described, is a printed 3D illusion on a garment in which the print is body-specific; that is, the printed illusion on the clothing relates in a meaningful way to the wearer's body. The second category also employs printed photographic illusions that appear three dimensional, but may or may not be related to the underlying body: even if the 3D illusion is not body-specific, it is nonetheless effective because of the precise digital optical illusion of three dimensionality. Any real 3D items such as petals, leaves, fish scales, feathers or textures, can be photographed with angled light that emphasizes their three dimensionality and then printed on fabric and used for any aesthetic or functional purpose. The items that are placed on the torso model and photographed are referred to as a ‘visual treatment’

There is a gradation between body-specific 3D illusion printing and non-body related 3D illusion printing, so that the printed contours of the wearer's body can be emphasized to any degree, or not at all.

Body-specific printing always refers to the wearer's body in a meaningful way. Therefore, the printing is done on some kind of fabric that covers the body. But the category of 3D illusion printing that doesn't necessarily relate to the wearer of a garment are broader and can apply to 3D illusions printed on fabric for any aesthetic or functional use. For instance, fabric printed with a photograph of dew drops could make a handsome garment or visually interesting drapes or vinyl upholstery, etc. Another example is folds in cloth that can be stage lit with colored lighting, photographed, and then printed on flat fabric that then has the illusion of 3D folds. Such fabric with illusory folds can have many applications. It could be printed with continuous drum printers to make printed yardage.

While printing on fabric from photographs is known, the difference here is the specific intention of creating printed 3D optical illusions to print on fabric for any purpose.

While the invention has been described with reference to the preferred embodiment, various modifications would be obvious to one of ordinary skill in the art. The invention encompasses such variations and modifications. Specifically, any optical illusion of a three dimensional object or objects printed on fabric or film for any use is encompassed.

I claim:

1. A method of printing graphics on fabric, comprising
creating a flattened model of a human torso,
covering the flattened model with a visual treatment,
photographing the covered flattened model, and
printing the photograph onto the fabric.

2. The method of claim 1, wherein said fabric is a garment, resulting in a printed optical illusion of three-dimensionality that relates to the wearer's body in a visually meaningful way.

3. The method of claim 1, wherein
said fabric is precut before printing and sewn into an article of clothing after printing.

4. The method of claim 1, wherein the fabric is printed as yardage, then cut and sewn to make an article of clothing

5. The method of claim 1, wherein
creating a flattened model of a human torso comprises
forming a negative mold on a model,
forming a positive cast from said negative mold, and partially
flattening said positive cast.

6. The method of claim 5, further comprising
forming said positive cast from flexible material.

7. The method of claim 5, wherein said positive cast of the front of the model covers more than 180 degrees of the front of the torso.

8. The method of claim 5, wherein said positive cast of the back of the model covers more than 180 degrees of the back of the torso.

9. The method of claim 1, further comprising
covering the flattened torso with a uniform, costume or other apparel before photographing.

10. A method for printing graphics on fabric, comprising
covering a torso with a three dimensional visual treatment,
photographing the torso from different vantage points,
overlapping the photographs to create a single, seamless, master photograph, and
printing the master photograph on fabric to be made into a garment that has the
optical illusion of the three dimensional visual treatment.

11. The method of claim 10, wherein the front of
said torso is photographed from at least three different vantage points and the back of said torso is photographed from at least three different vantage points.

12. The method of claim 10, wherein
a first vantage point is normal to said torso,
a second vantage point is 45 degrees to the left of the first vantage point,
a third vantage point is 45 degrees to the right of the first vantage point,
a fourth vantage point is 45 degrees above said second vantage point,
a fifth vantage point is 45 degrees above said third vantage point.

13. The method of printing the front panel of a t-shirt simultaneously with the front of the sleeves of said t-shirt and then printing the back panel simultaneously with the back of the sleeves.

14. The method of printing, as in claim 13, wherein a t-shirt is stretched on a thin t-shirt-shaped armature to keep the t-shirt flat during printing, which results in a t-shirt printed full round or nearly full round.

15. A method of printing on fabric, as described in claim 13, so that the printed optical illusion image, when worn as a garment, relates to the underlying body of the wearer in a meaningful way.
